(19) United States
(12) Patent Application Publication
(10) Pub. No.: US 2024/0145140 A1
(43) Pub. Date: May 2, 2024

(54) MAGNETIC BASE BODY, COIL COMPONENT INCLUDING THE MAGNETIC BASE BODY, CIRCUIT BOARD INCLUDING THE COIL COMPONENT, AND ELECTRONIC DEVICE INCLUDING THE CIRCUIT BOARD

(71) Applicant: TAIYO YUDEN CO., LTD., Tokyo (JP)

(72) Inventors: Yusuke OSHIMA, Tokyo (JP); Tomoya HAGIWARA, Tokyo (JP); Tatsuya TOMITA, Tokyo (JP)

(21) Appl. No.: 18/497,475

(22) Filed: Oct. 30, 2023

(30) Foreign Application Priority Data
Oct. 31, 2022 (JP) 2022-174373

(51) Int. Cl. H01F 1/147; H01F 17/00

(52) U.S. Cl. CPC H01F 1/14791; H01F 17/0013

(57) ABSTRACT

A magnetic base body according to one embodiment includes: a plurality of soft magnetic metal particles; and a plurality of insulating films covering surfaces of the plurality of soft magnetic metal particles. The plurality of soft magnetic metal particles include a first soft magnetic metal particle, and the plurality of insulating films include a first insulating film covering a surface of the first soft magnetic metal particle. The first insulating film includes one or more first oxide regions, the one or more first oxide regions containing Fe and Cr and having a peak intensity at 730 cm⁻¹ in a Raman spectrum obtained by Raman spectrometry.

### CROSS-REFERENCE TO RELATED APPLICATIONS

This application is based on and claims the benefit of priority from Japanese Patent Application Serial No. 2022-174373 (filed on Oct. 31, 2022), the contents of which are hereby incorporated by reference in their entirety.

### TECHNICAL FIELD

The present disclosure relates mainly to a magnetic base body, a coil component including the magnetic base body, a circuit board including the coil component, and an electronic device including the circuit board.

### BACKGROUND

Some coil components include a soft magnetic base body containing a plurality of soft magnetic metal particles made of a soft magnetic material. In the soft magnetic base body, the surfaces of the soft magnetic metal particles are covered with insulating films, and adjacent soft magnetic metal particles are bonded to each other via the insulating films. Since the soft magnetic base body is less prone to magnetic saturation than a magnetic base body made of ferrite, the soft magnetic base body is suitable particularly for coil components used in large-current circuits.

The soft magnetic metal particles are made of a soft magnetic material mainly composed of Fe, for example. The magnetic base body is fabricated by mixing raw powder made of a soft magnetic material with a resin to produce a mixed resin composition, and then heating the mixed resin composition. Since Fe contained in the raw powder particles is oxidized by heating, an insulating film containing oxides of Fe is formed on the surfaces of the raw powder particles. This insulating film electrically insulates adjacent soft magnetic metal particles from one another. The insulating film also contains oxides of elements other than Fe added into the raw powder.

The magnetic base body disclosed in Japanese Patent Application Publication No. 2021-158261 has an insulating film formed of four oxide layers stacked on the surfaces of the soft magnetic metal particles, so as to improve the voltage resistance between the soft magnetic metal particles. In this insulating film, the second and fourth oxide layers contain Fe oxides as the main component.

The Fe oxides contained in the insulating film covering the soft magnetic metal particles are known to be present in the form of magnetite (Fe₃O₄) or hematite (Fe₂O₃). Since magnetite is ferromagnetic, the presence of magnetite in the insulating film causes unevenness in the specific permeability between soft magnetic metal particles. Therefore, if the content percentage of magnetite in the insulating film is large, local magnetic saturation tends to occur in the region where magnetite is present, which degrades the magnetic saturation characteristics of the magnetic base body.

Since hematite is nonmagnetic, the degradation of the magnetic saturation characteristics of the magnetic base body can be inhibited by increasing the content percentage of hematite in the insulating film. However, in order to form hematite from Fe contained in the raw powder, it is necessary to supply a large amount of oxygen to the vicinity of the surface of the raw powder during heating. When the raw powder is heated in an atmosphere with high oxygen concentration to increase the content percentage of hematite, the oxidation of Fe and additive elements other than Fe contained in the raw powder may progress excessively, causing the insulating film to grow to a thickness larger than required to ensure voltage resistance. Excessively grown insulating film reduces the filling factor of the soft magnetic metal particles in the magnetic base body, leading to degradation of the magnetic characteristics of the magnetic base body.

### SUMMARY

It is an object of the present disclosure to solve or alleviate at least part of the drawbacks mentioned above. More specifically, one object of the invention disclosed herein is to provide a magnetic base body having excellent magnetic saturation characteristics and magnetic characteristics.

Other objects of the disclosure will be made apparent through the entire description in the specification. The inventions recited in the claims may also address any other drawbacks in addition to the above drawback.

A magnetic base body according to one embodiment comprises: a plurality of soft magnetic metal particles; and a plurality of insulating films covering surfaces of the plurality of soft magnetic metal particles. The plurality of soft magnetic metal particles include a first soft magnetic metal particle, and the plurality of insulating films include a first insulating film covering a surface of the first soft magnetic metal particle. The first insulating film includes one or more first oxide regions, the one or more first oxide regions containing Fe and Cr and having a peak intensity at 730 cm⁻¹ in a Raman spectrum obtained by Raman spectrometry.

### Advantageous Effects

According to the embodiments of the invention disclosed herein, it is possible to provide a magnetic base body having excellent magnetic saturation characteristics and magnetic characteristics.

### BRIEF DESCRIPTION OF THE DRAWINGS

FIG. 1 is a schematic perspective view showing a coil component including a magnetic base body according to one embodiment of the present invention.

FIG. 2 is an exploded perspective view of the coil component shown in FIG. 1.

FIG. 3 is a sectional view schematically showing a section of the coil component of FIG. 1 along the line I-I.

FIG. 4 is an enlarged sectional view schematically showing, on an enlarged scale, a part of a section of the magnetic base body according to one embodiment.

FIG. 5 is an enlarged sectional view schematically showing, on an enlarged scale, a part of a section of the magnetic base body according to another embodiment.

FIG. 6 is a flow chart showing a process of manufacturing a coil component according to one embodiment of the present invention.

FIG. 7 is a flow chart showing a process of manufacturing a coil component according to another embodiment of the present invention.

### DESCRIPTION OF THE PREFERRED EMBODIMENTS

Various embodiments of the present invention will be described hereinafter with reference to the appended drawings. Throughout the drawings, the same components are denoted by the same reference numerals. For convenience of explanation, the drawings are not necessarily drawn to scale. The following embodiments of the present invention do not limit the scope of the claims. The elements included in the following embodiments are not necessarily essential to solve the problem addressed by the invention.

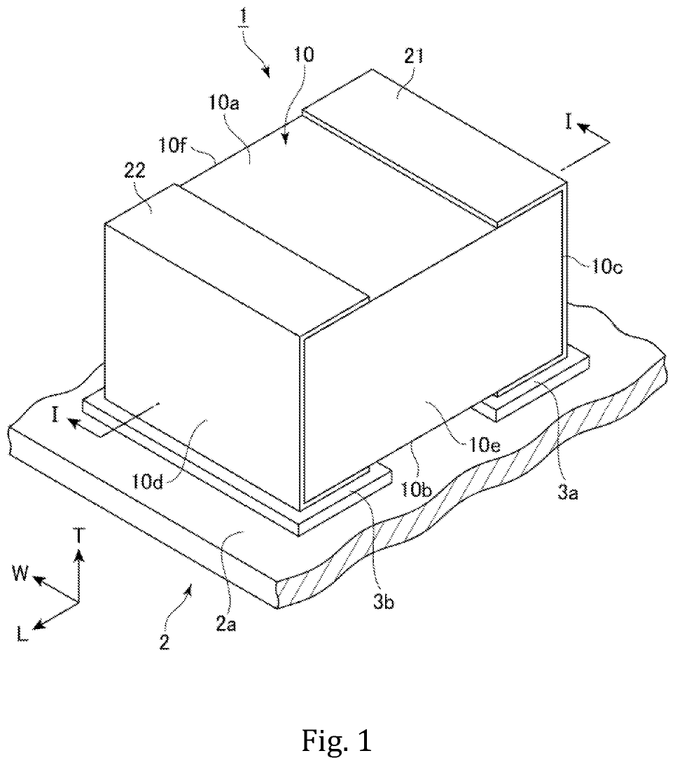

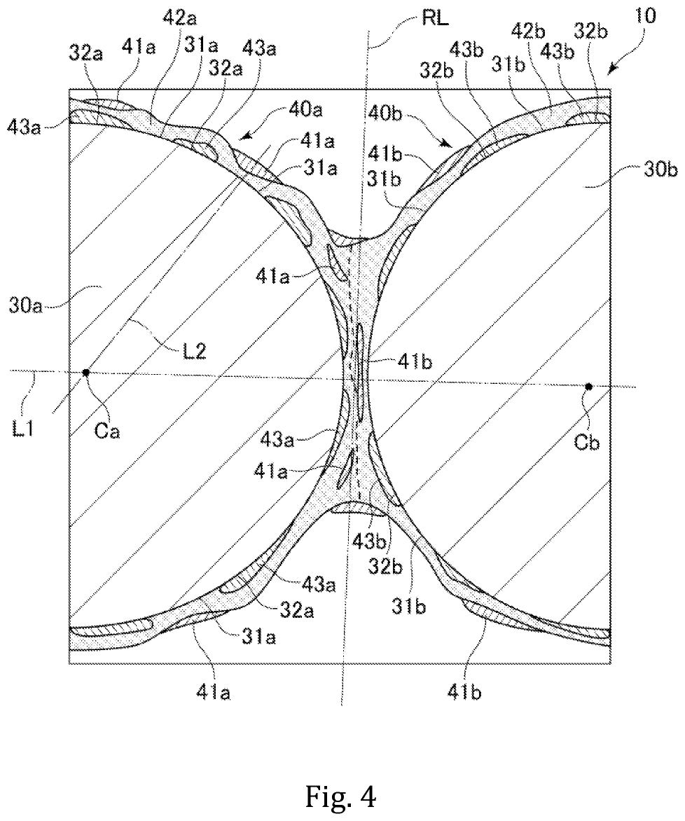

The embodiments of the present disclosure relate to a magnetic base body of a coil component. The magnetic based body contains a plurality of soft magnetic metal particles. The following first describes a coil component 1 including a magnetic base body relating to one embodiment with reference to FIGS. 1 to 3, and then the microstructure of the magnetic base body with reference to FIGS. 4 to 6.

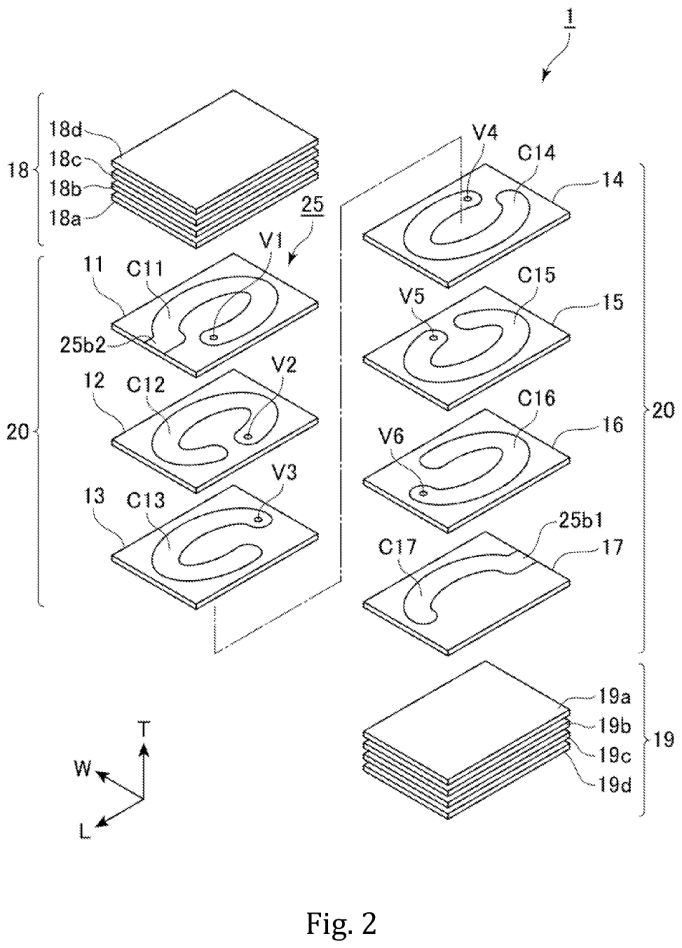

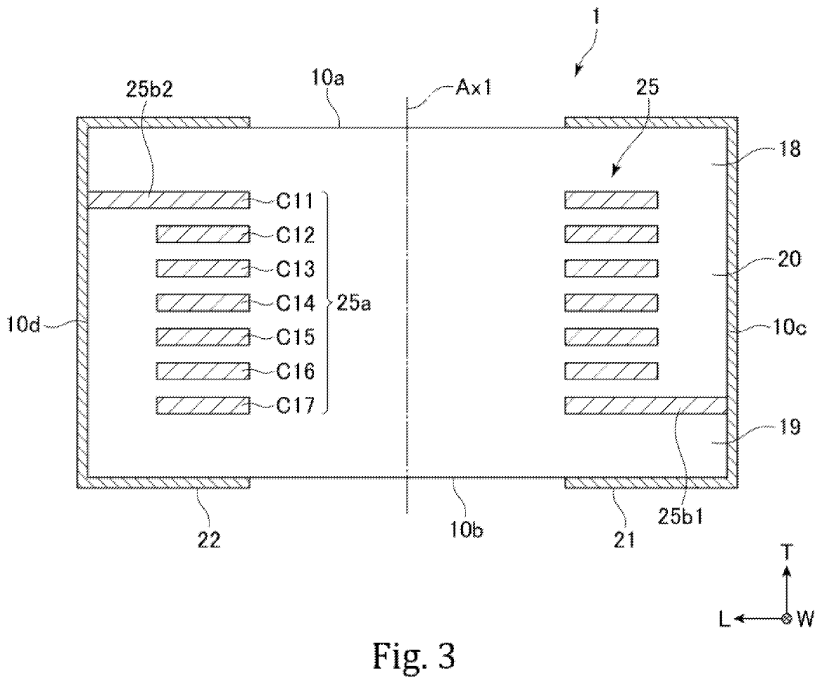

FIG. 1 is a schematic perspective view of the coil component 1, and FIG. 2 is an exploded perspective view of the coil component 1. FIG. 3 is a schematic sectional view of the coil component 1 along the line I-I of FIG. 1. In FIG. 2, external electrodes are not shown for convenience of description.

By way of one example of the coil component 1, FIGS. 1 to 3 show a laminated inductor. The laminated inductor shown is an example of the coil component 1 to which the invention can be applied. The invention can also be applied to various coil components other than the laminated inductor. For example, the coil component 1 may be applied to wire-wound coil components or planar coils.

As shown, the coil component 1 includes a base body 10, a coil conductor 25 provided in the base body 10, an external electrode 21 disposed on a surface of the base body 10, and an external electrode 22 disposed on the surface of the base body 10 at a position spaced apart from the external electrode 21. The base body 10 is a magnetic base body made of a magnetic material. The base body 10 is an example of the “magnetic base body” recited in the claims.

The base body 10 contains a lot of soft magnetic metal particles. An average particle size of the soft magnetic metal particles contained in the base body 10 is, for example, 1 μm to 20 μm. The average particle diameter of the soft magnetic metal particles contained in the base body 10 is determined as follows. The base body 10 is cut along the thickness direction (T axis direction) to expose a section, and the section is scanned by a scanning electron microscope (SEM) to take an SEM image at an approximately 10000 to 50000-fold magnification. The SEM image is analyzed to determine the equivalent circle diameter (Heywood diameter) of each soft magnetic metal particle, and the average of the equivalent circle diameters of the soft magnetic metal particles is taken as the average particle diameter of the soft magnetic metal particles. The average particle diameter of the soft magnetic metal particles contained in the base body 10 may be 1 μm to 10 μm or may be 2 μm to 8 μm. Since the average particle diameter of the soft magnetic metal particles does not differ significantly from that of the raw powder, the particle size distribution of the raw powder may be measured by the laser diffraction scattering method according to JIS Z 8825, and the D50 value of the volume-based particle size distribution measured by the laser diffraction scattering method may be taken as the average particle diameter of the soft magnetic metal particles in the base body 10.

The external electrode 21 is electrically connected to one end of the coil conductor 25, and the external electrode 22 is electrically connected to the other end of the coil conductor 25.

The coil component 1 may be mounted on a mounting substrate 2a. In the embodiment shown, the mounting substrate 2a has lands 3a and 3b provided thereon. The coil component 1 is mounted on the mounting substrate 2a by bonding the external electrode 21 to the land 3a and bonding the external electrode 22 to the land 3b. A circuit board 2 according to one embodiment of the present invention includes the coil component 1 and the mounting substrate 2a having the coil component 1 mounted thereon. The circuit board 2 can be installed in various electronic devices. The electronic devices in which the circuit board 2 can be installed include smartphones, tablets, game consoles, electrical components of automobiles, servers, and various other electronic devices.

The coil component 1 may be an inductor, a transformer, a filter, a reactor, an inductor array and any one of various other coil components. The coil component 1 may alternatively be a coupled inductor, a choke coil, and any one of various other magnetically coupled coil components. Applications of the coil component 1 are not limited to those explicitly described herein.

In one embodiment of the present invention, the base body 10 is configured such that the dimension in the L-axis direction (length dimension) is greater than the dimension in the W-axis direction (width dimension) and the dimension in the T-axis direction (height dimension). For example, the length dimension is from 1.0 mm to 6.0 mm, the width dimension is from 0.5 mm to 4.5 mm, and the height dimension is from 0.5 mm to 4.5 mm. The dimensions of the base body 10 are not limited to those specified herein. The term “rectangular parallelepiped” or “rectangular parallelepiped shape” used herein is not intended to mean solely “rectangular parallelepiped” in a mathematically strict sense. The dimensions and the shape of the base body 10 are not limited to those specified herein.

The base body 10 has a first principal surface 10a, a second principal surface 10b, a first end surface 10c, a second end surface 10d, a first side surface 10e, and a second side surface 10f. The outer surface of the base body 10 is defined by these six surfaces. The first principal surface 10a and the second principal surface 10b are at the opposite ends in the height direction of the base body 10, the first end surface 10c and the second end surface 10d are at the opposite ends in the length direction of the base body 10, and the first side surface 10e and the second side surface 10f are at the opposite ends in the width direction of the base body 10. As shown in FIG. 1, the first principal surface 10a is at the top of the base body 10, and therefore, the first principal surface 10a may be referred to as a “top surface.” Likewise, the second principal surface 10b may be referred to as a “lower surface” or “bottom surface.” Since the coil component 1 is disposed such that the second principal surface 10b faces the mounting substrate 2a, the second principal surface 10b may be herein referred to as “the mounting surface.” The top surface 10a and the bottom surface 10b are separated from each other by a distance equal to the height of the base body 10, the first end surface 10c and the second end surface 10d are separated from each other by a distance equal to the length of the base body 10, and the first side surface 10e and the second side surface 10f are separated from each other by a distance equal to the width of the base body 10.

As shown in FIG. 2, the base body 10 includes a body layer 20, a bottom cover layer 19 provided on the bottom-side surface of the body layer 20, and a top cover layer 18 provided on the top-side surface of the body layer 20. The top cover layer 18, bottom cover layer 19, and body layer 20 are the components of the base body 10.

The body layer 20 includes magnetic films 11 to 17. In the body layer 20, the magnetic films 17, 16, 15, 14, 13, 12 and 11 are stacked in the stated order from the negative side toward the positive side in the T-axis direction.

The magnetic films 11 to 17 respectively have conductor patterns C11 to C17 formed on the top-side surface thereof. The conductor patterns C11 to C17 each extend around a coil axis Ax1 (see FIG. 3) within a plane orthogonal to the coil axis Ax1 (the LW plane). The conductor patterns C11 to C17 are formed by, for example, printing a conductive paste made of a highly conductive metal or alloy via screen printing. The conductive paste may be made of Ag, Pd, Cu, Al, or alloys thereof. The conductive paste is produced by mixing and kneading conductive powder made of conductive materials having excellent conductivity, such as Ag, Pd, Cu, Al or alloys of these, with a binder resin and a solvent. The binder resin may be epoxy resins, polyimide resins, resins known as binder resins other than those mentioned above, or mixtures thereof. When Cu powder is used as the conductive powder, a thermally decomposable resin such as acrylic resin may be used as the binder resin to prevent excessive oxidation of the Cu powder during degreasing. The thermally decomposable resin decomposes without combustion reaction with oxygen. The thermally decomposable resin thermally decomposes in a non-oxygen atmosphere (e.g., nitrogen atmosphere) when the temperature is raised above the thermal decomposition temperature, leaving no residue. Therefore, by using a thermally decomposable resin as the binder resin, the degreasing process can be performed in a non-oxygen atmosphere. Examples of the acrylic resin for the conductive paste include (meth)acrylic acid copolymers, (meth)acrylic acid-(meth)acrylic ester copolymers, styrene-(meth)acrylic acid copolymers, or styrene-(meth)acrylic acid-(meth)acrylic ester copolymers. The solvent may be toluene, ethanol, turpineol, or mixtures of these. The conductive paste may contain modifiers for adjusting thixotropy. The conductor patterns C11 to C17 may be formed using other methods and materials. For example, the conductor patterns C11 to C17 may be formed by sputtering, ink-jetting, or other known methods.

The magnetic films 11 to 16 have vias V1 to V6, respectively, at a predetermined position therein. The vias V1 to V6 are formed by forming a through hole at the predetermined position in the magnetic films 11 to 16 so as to extend through the magnetic films 11 to 16 in the T axis direction and filling the through holes with a conductive material. Each of the conductor patterns C11 to C17 is electrically connected to the respective adjacent conductor patterns through the vias V1 to V6.

The end of the conductor pattern C11 opposite to the end thereof connected to the via V1 is connected to the external electrode 22. The end of the conductor pattern C17 opposite to the end thereof connected to the via V6 is connected to the external electrode 21.

The top cover layer 18 includes magnetic films 18a to 18d made of a magnetic material, and the bottom cover layer 19 includes magnetic films 19a to 19d made of a magnetic material. In this specification of the present invention, the magnetic films 18a to 18d and the magnetic films 19a to 19d may be referred to collectively as “the cover layer magnetic films.”

As shown in FIG. 3, the coil conductor 25 includes a winding portion 25a wound around the coil axis Ax1 extending along the thickness direction (T-axis direction), a lead-out portion 25b1 that extends from one end of the winding portion 25a to the first end surface 10c of the base body 10, and a lead-out portion 25b2 that extends from the other end of the winding portion 25a to the second end surface 10d of the base body 10. The conductor patterns C11 to C17 and the vias V1 to V6 form the winding portion 25a having a spiral shape. In other words, the winding portion 25a is constituted by the conductor patterns C11 to C17 and the vias V1 to V6.

The following now describes the microstructure of the base body 10 with reference to FIG. 4. FIG. 4 is an enlarged sectional view schematically showing, on an enlarged scale, a part of the section shown in FIG. 3. FIG. 4 schematically shows portions of two of the many soft magnetic metal particles in the base body 10.

As shown in FIG. 4, the soft magnetic metal particles contained in the base body 10 include a first soft magnetic metal particle 30a and a second soft magnetic metal particle 30b. The first soft magnetic metal particle 30a and the second soft magnetic metal particle 30b are positioned adjacent to each other. In FIG. 4, the sections of the first soft magnetic metal particle 30a and the second soft magnetic metal particle 30b are drawn to be circular for convenience. The soft magnetic metal particles contained in the base body 10 can take various sectional shapes other than the circular shape. The soft magnetic metal particles contained in the base body 10 are mainly composed of Fe. The first soft magnetic metal particle 30a and the second soft magnetic metal particle 30b are examples of the soft magnetic metal particles contained in the base body 10. The description regarding the first soft magnetic metal particle 30a and the second soft magnetic metal particle 30b also applies to soft magnetic metal particles other than the first soft magnetic metal particle 30a or the second soft magnetic metal particle 30b contained in the base body 10.

The soft magnetic metal particles contained in the base body 10 should preferably contain Fe at a content percentage of 95 wt % or more so that the base body 10 has high magnetic saturation characteristics. The content percentage of Fe in the soft magnetic metal particles contained in the base body 10 is measured by cutting the base body 10 along the coil axis Ax to expose a section of the base body 10 and performing energy dispersive X-ray spectroscopy (EDS) analysis on this section. The content percentage of Fe can be measured by scanning electron microscopy (SEM) equipped with an energy dispersive X-ray spectroscopy (EDS) detector. The EDS analysis by SEM equipped with an EDS detector is called SEM-EDS analysis. The content percentage of Fe is measured, for example, using a scanning electron microscope SU7000 from Hitachi High Tech Corporation and an energy dispersive X-ray spectroscopy detector Octane Elite from Ametek Inc. at an acceleration voltage of 5 kV. The content percentages of elements other than Fe contained in the first soft magnetic metal particle 30a are also measured by SEM-EDS analysis, as is the content percentage of Fe.

The surface of each of the soft magnetic metal particles contained in the base body 10 is covered by an insulating film. Thus, the soft magnetic metal particles contained in the base body 10 are electrically insulated from each other. For example, the surface of the first soft magnetic metal particle 30a is covered by the first insulating film 40a, and the surface of the second soft magnetic metal particle 30b is covered by the second insulating film 40b. The first insulating film 40a should preferably cover the entire surface of the first soft magnetic metal particle 30a, and the second insulating film 40b should preferably cover the entire surface of the second soft magnetic metal particle 30b. In the base body 10, each soft magnetic metal particle is bonded to adjacent soft magnetic metal particles via insulating films provided on their respective surfaces. In other words, the insulating films provided on the surfaces of adjacent soft magnetic metal particles are bonded to each other, and this bonding of the insulating films forms bonding of the soft magnetic metal particles covered by the insulating films. For example, the first soft magnetic metal particle 30a is bonded to the second soft magnetic metal particle 30b adjacent to the first soft magnetic metal particle 30a via the first insulating film 40a provided on the surface of the first soft magnetic metal particle 30a and the second insulating film 40b provided on the surface of the second soft magnetic metal particle 30b.

The soft magnetic metal particles contained in the base body 10 are produced, for example, by heating a raw powder made of soft magnetic material. As will be described later, the base body 10 may be fabricated by mixing soft magnetic metal powder made of a soft magnetic material with a resin to produce a mixed resin composition, and then heating the mixed resin composition. The heat treatment in the manufacturing process of the base body 10 causes the elements contained in the raw powder to diffuse to the surface of the raw powder and oxidize on the surface of the raw powder, and as a result, insulating films that contain oxides of the elements contained in the raw powder are formed on the surfaces of the soft magnetic metal particles.

The raw powder for the soft magnetic metal particles contained in the base body 10 is mainly composed of Fe. The raw powder of the soft magnetic metal particles contained in the base body 10 can contain additive elements in addition to Fe. For example, the raw powder of the soft magnetic metal particles contained in the base body 10 can contain Cr as an additive element in addition to Fe. In addition to Cr, the raw powder can contain element A and element B as additive elements.

The element A and the element B are more apt to oxidation than Fe. The element A may be more apt to oxidation than element B. In one embodiment, the elements A and B are more apt to oxidation than Cr. In one embodiment, the element A is Al. In one embodiment, the element B is Si. The element B may be Ti. Since Cr and the elements A and B are all more apt to oxidation than Fe, they are oxidized prior to Fe when the raw powder is heat-treated in an atmosphere containing oxygen. Thus, the presence of Cr and the elements A and B in addition to Fe in the raw powder inhibits the oxidation of Fe. The raw powder for the soft magnetic metal particles can contain trace amounts of elements other than Fe, Cr, the element A, and the element B. The elements that can be present in trace amounts in the raw powder for the soft magnetic metal particles can include vanadium (V), zinc (Zn), boron (B), carbon (C), and nickel (Ni).

The insulating films provided on the surfaces of the soft magnetic metal particles contained in the base body 10 contain oxides of the elements contained in the raw powder. The “insulating films provided on the surfaces of the soft magnetic metal particles contained in the base body 10” include the first insulating film 40a provided on the surface of the first soft magnetic metal particle 30a and the second insulating film 40b provided on the surface of the second soft magnetic metal particle 30b. For convenience of description, the insulating films provided on the surfaces of the soft magnetic metal particles contained in the base body 10 may be referred to simply as the “insulating films.” The elements A and B are more apt to oxidation than Fe. Thus, when the raw powder contains the elements A and B in addition to Fe, the insulating films contain the oxide of the element A and the oxide of the element B. In addition to the above oxides, the insulating film may contain oxide of at least one of vanadium (V), zinc (Zn), boron (B), carbon (C), and nickel (Ni). In one embodiment, the thickness of the insulating films is 5 to 20 nm.

With reference to FIG. 4, a further description is given of the insulating films covering the surfaces of the soft magnetic metal particles. In the embodiment shown in FIG. 4, the first insulating film 40a includes a first oxide region 41a containing oxides of Fe and Cr, a second oxide region 42a containing an oxide of the element A as the main component, and a third oxide region 43a containing an oxide of the element B as the main component.

The first oxide region 41a contains chromite (FeCr₂O₄). The first oxide region 41a may contain hematite (Fe₂O₃) and magnetite (Fe₃O₄) in addition to chromite (FeCr₂O₄). When the first oxide region 41a contains chromite, hematite, and magnetite, the content percentage of chromite is the highest, and the content percentage of magnetite is the lowest. Comparison of content percentages of chromite, hematite, and magnetite can be made by Raman spectroscopic analysis. More specifically, the base boy 10 is cut along the T axis to expose a section, and an excitation laser of 488 nm wavelength is applied to a region of this section near the first oxide region 41a. The resultant scattered light is measured to obtain a Raman spectrum. In this Raman spectrum, the peak intensities of the peaks obtained from chromite, hematite, and magnetite are compared. One with the higher peak intensity can be determined to have the higher content percentage. In the Raman spectrum, the peak near wavenumber 730 cm⁻¹ is obtained from chromite (FeCr₂O₄), the peak near wavenumber 680 cm⁻¹ is obtained from magnetite (Fe₃O₄), and the peak near wavenumber 300 cm⁻¹ is obtained from hematite (Fe₂O₃). The peak obtained from chromite (FeCr₂O₄) appears in the wavenumber range from 700 cm⁻¹ to 760 cm⁻¹ in the Raman spectrum. The peak obtained from magnetite (Fe₃O₄) appears in the wavenumber range from 640 cm⁻¹ to 700 cm⁻¹ in the Raman spectrum. The peak obtained from hematite (Fe₂O₃) appears in the wavenumber range from 270 cm⁻¹ to 330 cm⁻¹ in the Raman spectrum.

As mentioned above, among the content percentages of chromite, hematite, and magnetite in the first oxide region 41a, the content percentage of magnetite is the lowest. The presence of magnetite, which is ferromagnetic, between soft magnetic metal particles in the base body 10 facilitates local magnetic saturation in the region where magnetite is present. By increasing the content percentage of chromite, which is non-magnetic, over the content percentage of magnetite in the first oxide region 41a containing Fe, the uniformity of magnetic permeability among the soft magnetic metal particles can be improved, and as a result, the occurrence of local magnetic saturation between the soft magnetic metal particles can be inhibited. This improves the magnetic saturation characteristics of the base body 10 compared to conventional magnetic base bodies containing more magnetite.

In one embodiment, the first oxide region 41a may contain two or more times as much chromite as magnetite. For example, in the Raman spectrum obtained by Raman spectroscopic analysis on the first oxide region 41a, the magnitude of the peak near wavenumber 730 cm⁻¹ (i.e., the peak obtained from chromite) may be two or more times as large as the magnitude of the peak near wavenumber 680 cm⁻¹ (i.e., the peak obtained from magnetite). The high content percentage of chromite, which is non-magnetic, reduces the specific permeability of the insulating film and improves the magnetic saturation characteristics of the base body 10, compared to the case with a high content percentage of ferromagnetic oxides (e.g., magnetite). In another embodiment, the ratio among chromite, hematite, and magnetite contained in the first oxide region 41a may be set such that the magnitude of the peak around wavenumber 730 cm⁻¹ (i.e., the peak obtained from chromite) is more than one time the magnitude of the peak around wavenumber 300 cm⁻¹ (i.e., the peak obtained from hematite) in the Raman spectrum, and the magnitude of the peak around wavenumber 680 cm⁻¹ (i.e., the peak obtained from magnetite) is less than one time the magnitude of the peak around wavenumber 300 cm⁻¹ (i.e., the peak obtained from hematite) in the Raman spectrum. The higher content percentages of chromite and hematite, both being non-magnetic, than the content percentage of magnetite in the first oxide region 41a reduces the specific permeability of the insulating film and improves the magnetic saturation characteristics of the base body 10, compared to the case with a high content percentage of ferromagnetic oxides (e.g., magnetite).

When the element A is Al, the second oxide region 42a contains alumina (Al₂O₃) as the main component. In the case where the EDS analysis shows that the amount of Al element (atomic percentage (at %) of Al element) is the largest among those of the elements other than oxygen contained in the second oxide region 42a, it can be determined that the second oxide region 42a contains alumina as the main component. Since the second oxide region 42a is mainly composed of alumina, which is insulating, the second oxide region 42a has a high insulating quality. In the case where the second oxide region 42a may contain an oxide of aluminum other than alumina (e.g., aluminum oxide (II)), the Raman spectroscopic analysis may be used to determine that the oxide contained as the main component in the second oxide region 42a is alumina (aluminum oxide (III)) rather than aluminum oxide (II).

When the element B is Si, the third oxide region 43a contains silica (SiO₂) as the main component. In the case where the EDS analysis shows that the amount of Si element (atomic percentage (at %) of Si element) is the largest among those of the elements other than oxygen contained in the third oxide region 43a, it can be determined that the third oxide region 43a contains silica as the main component. Since the third oxide region 43a is mainly composed of silica, which is insulating, the third oxide region 43a has a high insulating quality. In the case where the third oxide region 43a may contain an oxide of silicon other than silica (e.g., silicon monoxide), the Raman spectroscopic analysis may be used to determine that the oxide contained as the main component in the third oxide region 43a is silica (silicon dioxide) rather than silicon monoxide.

The first oxide region 41a is spaced apart from the surface of the first soft magnetic metal particle 30a. In other words, at least one of the second oxide region 42a or the third oxide region 43a is interposed between the first oxide region 41a and the surface of the first soft magnetic metal particle 30a. In the embodiment shown, the first oxide region 41a is also spaced apart from the third oxide region 43a. In other words, the second oxide region 42a is interposed between the first oxide region 41a and the third oxide region 43a. It is also possible that the first oxide region 41a is in contact with the third oxide region 43a.

The second oxide region 42a covers a first surface region 31a, which is a part of the surface of the first soft magnetic metal particle 30a. The third oxide region 43a covers a second surface region 32a, which is a part of the surface of the first soft magnetic metal particle 30a. The surface of the first soft magnetic metal particle 30a is partitioned into the first surface region 31a and the second surface region 32a. Since the first surface region 31a of the surface of the first soft magnetic metal particle 30a is covered by the second oxide region 42a, and the second surface region 32a is covered by the third oxide region 43a, the entire surface of the first soft magnetic metal particle 30a is covered by the second and third oxide regions 42a and 43a each having a high insulating quality.

The second oxide region 42a may cover at least a part of the outer surface of the third oxide region 43a, in addition to the first surface region 31a of the first soft magnetic metal particle 31. The second oxide region 42a covering the outer surface of the third oxide region 43a can cover any portion of the third oxide region 43a having a defect, thereby preventing dielectric breakdown from occurring from the defect in the third oxide region 43a. In the aspect shown in FIG. 4, the entire outer surface of the third oxide region 43a is covered by the second oxide region 42a. The second oxide region 42a covering the entire outer surface of the third oxide region 43a further inhibits dielectric breakdown.

It is also possible that the second oxide region 42a covers only a part of the outer surface of the third oxide region 43a. In this case, the amount of the second oxide region 42a on the surface of the first soft magnetic metal particle 30a can be reduced. Therefore, the second oxide region 42a covering only a part of the outer surface of the third oxide region 43a can improve the filling factor of the soft magnetic metal particles in the base body 10, compared to the aspect in which the second oxide region 42a covers the entire outer surface of the third oxide region 43a.

The first oxide region 41a is located on the outer side of the second oxide region 42a in the radial direction of the first soft magnetic metal particle 30a. In one embodiment, at least one of a plurality of first oxide regions 41a may be provided at a position corresponding to the first surface region 31a in the circumferential direction around the first soft magnetic metal particle 30a. In other words, at least one of the plurality of first oxide regions 41a may be provided on the radially outer side of the first surface region 31a. The region corresponding to the first surface region 31a in the circumferential direction of the first soft magnetic particle 30a contains only the second oxide region 42a and does not contain the third oxide region 43a. On the other hand, the region corresponding to the second surface region 32a in the circumferential direction of the first soft magnetic particle 30a contains the third oxide region 43a and the second oxide region 42a provided on the radially outer side thereof. Therefore, the second oxide region 42a is concave inwardly at a position corresponding to the first surface region 31a in the circumferential direction of the first soft magnetic metal particle 30a. In one embodiment, the first oxide region 41a is located in a cavity of the second oxide region 42a at a position corresponding to the first surface region 31a in the circumferential direction of the first soft magnetic metal particle 30a. Since the first oxide region 41a is provided in the cavity of the second oxide region 42a, the thickness of the first insulating film 40a can be uniform in the circumferential direction. In the case where a portion of the first insulating film 40a is thinner than other portions, dielectric breakdown may occur from the thinner portion. The uniform thickness of the first insulating film 40a in the circumferential direction prevents dielectric breakdown from occurring from a thin portion of the first insulating film 40a. In the case where the first oxide region 41a is provided on the radially outer side of the first surface region 31a, the straight line connecting the geometric center Ca of the first soft magnetic metal particle 30a and the first oxide region 41a provided on the radially outer side of the first surface region 31a passes through the second oxide region 42a but not through the third oxide region 43a.

As with the first oxide region 41a, the first oxide region 41b is spaced apart from the surface of the second soft magnetic metal particle 30b. The first oxide region 41b may also be spaced apart from the third oxide region 43b. It is also possible that the first oxide region 41b is in contact with the third oxide region 43b. Further, the first oxide region 41b may be located in a cavity of the second oxide region 42b at a position corresponding to the first surface region 31b in the circumferential direction of the second soft magnetic metal particle 30b.

In the embodiment shown in FIG. 4, the first insulating film 40a includes a plurality of third oxide regions 43a that are spaced apart from each other. In this way, the oxide of the element B is not formed in a layer covering the entire surface of the first soft magnetic metal particle 30a, but is formed into a plurality of separate third oxide regions 43a on the surface of the first soft magnetic metal particle 30a. With a trace amount of element B contained in the raw powder, the plurality of third oxide regions 43a can be formed discretely on the surface of the first soft magnetic metal particle 30a. The amount of element B added in the raw powder to form the third oxide regions 43a discretely on the surface of the first soft magnetic metal particle 30a is, for example, 3 wt % or less. The amount of element B added in the raw powder may be 1 to 3 wt %.

A second insulating film 40b is provided on the surface of the second soft magnetic metal particle 30b, which is positioned adjacent to the first soft magnetic metal particle 30a. The second insulating film 40b includes a first oxide region 41b containing oxides of Fe and Cr, a second oxide region 42b containing an oxide of the element A as the main component, and a third oxide region 43b containing an oxide of the element B as the main component. The second oxide region 42b covers a first surface region 31b, which is a part of the surface of the second soft magnetic metal particle 30b. The third oxide region 43b covers a second surface region 32b, which is a part of the surface of the second soft magnetic metal particle 30b. The above description related to the first oxide region 41a applies to the first oxide region 41b. The above description related to the second oxide region 42a applies to the second oxide region 42b. The third oxide region 43b contains an oxide of the element B as a main component, as does the third oxide region 43a. The above description related to the third oxide region 43a applies to the third oxide region 43b.

In FIG. 4, the boundary between the first insulating film 40a and the second insulating film 40b is shown with a broken line, but the boundary between the first insulating film 40a and the second insulating film 40b may not be clearly visible when the cross section of the base body 10 is observed.

FIG. 4 shows the geometric center Ca of the first soft magnetic metal particle 30a, the geometric center Cb of the second soft magnetic metal particle 30b, and an imaginary straight line L1 passing through these geometric centers Ca and Cb. Also shown in FIG. 4 is a reference line RL that intersects perpendicularly with the imaginary straight line L1 passing through the geometric centers Ca and Cb and is at an equal distance from the surface of the first soft magnetic metal particle 30a and the surface of the second soft magnetic metal particle 30b. The distance between the first soft magnetic metal particle 30a and the reference line RL refers to the shortest length of a perpendicular line drawn from any point in the surface of the first soft magnetic metal particle 30a down to the reference line RL. Likewise, the distance between the second soft magnetic metal particle 30b and the reference line RL refers to the shortest length of a perpendicular line drawn from any point in the surface of the second soft magnetic metal particle 30b down to the reference line RL. The second insulating film 40b is asymmetric to the first insulating film 40a with respect to the reference line RL. For example, the third oxide region 43b contained in the second insulating film 40b is positioned asymmetrically to the third oxide region 43a contained in the first insulating film 40a with respect to the reference line RL. In the embodiment shown in FIG. 4, observation of the region between the surface of the first soft magnetic metal particle 30a and the surface of the second soft magnetic metal particle 30b along the straight line L1 reveals the following: for the first soft magnetic metal particle 30a, the third oxide region 43a is provided on the surface of the first soft magnetic metal particle 30a, and the second oxide region 42a is provided on the outer side of the third oxide region 43a, but for the second soft magnetic metal particle 30b, only the second oxide region 42b is provided on the surface of the second soft magnetic metal particle 30b. In this way, the asymmetry of the first and second insulating films 40a and 40b with respect to the reference line RL may be confirmed by observing the first and second insulating films 40a and 40b along the line L1.

In the base body 10, the entire surfaces of the soft magnetic metal particles are covered by the insulating film containing two kinds of oxides, or the oxides of the element A and the element B, and thus the voltage resistance of the base body 10 can be increased. In order to achieve high voltage resistance with an insulating film composed of a single kind of oxide, the entire surfaces of the soft magnetic metal particles must be covered by a layer of this oxide. However, if the element to be oxidized diffuses unevenly during the manufacturing process of the base body 10, the oxide of this elements may not be formed on a part of the surfaces of the soft magnetic metal particles. In this case, the part of the surfaces of the soft magnetic metal particles is not covered by the insulating film and is exposed, and thus the voltage resistance of the magnetic base body is degraded. In the base body 10 of the present application, the insulating film contains oxides of two different elements, so the surfaces of the soft magnetic metal particles are coated with an insulating film containing oxides of two different elements. Therefore, even if there are regions on the surfaces of the soft magnetic metal particles that are not coated with the oxide of one element, those regions can be coated with the oxide of the other element. Specifically, in the base body 10, the third oxide region 43a is formed only on a part of the first soft magnetic metal particle 30a (i.e., only on the second surface region 32a), while the second oxide region 42a, which is mainly composed of the oxide of the element A, covers the other region of the surface of the first soft magnetic metal particle 30a (i.e., the first surface region 31a). Therefore, the decrease in voltage resistance due to partial exposure of the surface of the first soft magnetic metal particle 30a can be inhibited. The soft magnetic metal particles other than the first soft magnetic metal particle 30a contained in the base body 10 are also covered by the insulating film containing the oxides of two different elements (i.e., the element A and the element B), and thus the base bodies 10 of these soft magnetic metal particles can have a high voltage resistance.

A description will now be given of the difference between the insulating film provided on the surfaces of the soft magnetic metal particles contained in the base body 10 of the present application (e.g., the first insulating film 40a) and the insulating film provided on the surfaces of the conventional soft magnetic metal particles. Conventionally, in the case where the insulating film covering the surfaces of soft magnetic metal particles contains oxides of two or more elements, the insulating film has a layered structure in which the oxide of each element is formed in a layer and these oxide layers are stacked. In other words, the insulating film of the conventional magnetic base body includes a first oxide layer mainly composed of the oxide of a first element and a second oxide layer mainly composed of the oxide of a second element. The first oxide layer covers the entire outer surface of the soft magnetic metal particle, and the second oxide layer covers the entire surface of the first oxide layer. One example of the conventional magnetic base body in which the insulating film has a layered structure is disclosed in Japanese Patent Application Publication No. 2021-158261.

In contrast, in the base body 10 of the present application, the first surface region 31a of the surface of the first soft magnetic metal particle 30a is covered by the second oxide region 42a, and the second surface region 32a of the first soft magnetic metal particle 30a is covered by the third oxide region 43a. Therefore, in the base body 10 to which the present invention is applied, the proportion of the insulating film in the base body 10 can be reduced compared to the conventional magnetic base bodies that have an insulating film with two or more oxide layers stacked together. As a result, the filling factor of the soft magnetic metal particles in the base body 10 can be increased, and thus the magnetic characteristics can be improved compared to conventional magnetic base bodies having an insulating film with two or more oxide layers stacked together.

As mentioned above, the chromite in the insulating films covering the surfaces of the soft magnetic metal particles contained in the base body 10 may be formed from the Fe and Cr in the raw powder of the soft magnetic metal particles, but in another embodiment, it is possible that the chromite is not formed from the raw powder of the soft magnetic metal particles. For example, metallic chromium particulate powder having a submicron particle diameter may be mixed with the raw powder of the soft magnetic metal particles, and this mixed powder may be mixed with a resin to produce a mixed resin composition. This mixed resin composition may be heated. In this way, the insulating films covering the surfaces of the soft magnetic metal particles can contain chromite not formed from Fe and Cr contained in the raw powder. Another method is as follows. The surface of raw powder of the soft magnetic metal particles may be coated with metallic chromium by a powder sputtering method to prepare a raw powder having a surface coated with metallic chromium. Alternatively, metallic chromium powder may be adhered to raw powder by a mechanochemical method to prepare a raw powder having a surface to which metallic chromium powder is adhered. By using any of these raw powders, the insulating films covering the surfaces of soft magnetic metal particles can contain chromite not formed from Fe and Cr contained in the raw powder.

As mentioned above, the oxide of the element B in the insulating films covering the surfaces of the soft magnetic metal particles contained in the base body 10 may be formed from the element B in the raw powder of the soft magnetic metal particles, but in another embodiment, it is possible that the oxide of the element B is not formed from the raw powder of the soft magnetic metal particles. In the case where the element B is Si, Si oxide (silica) can be formed on the surface of the raw powder (soft magnetic metal particles) by impregnating the raw powder with a mixed solution of TEOS (tetraethoxysilane), ethanol, and ammonia water, stirring this mixed solution, and then drying it. This allows Si oxide that is not formed from the Si element contained in the raw powder to adhere to the surface of the soft magnetic metal particles. The third oxide regions 43a and 43b may be made of silica formed on the surfaces of the soft magnetic metal particles. In the case where the oxide of the element B in the insulating film covering the surfaces of the soft magnetic metal particles is not formed from an element contained in the raw powder, it is possible that the raw powder does not contain element B.

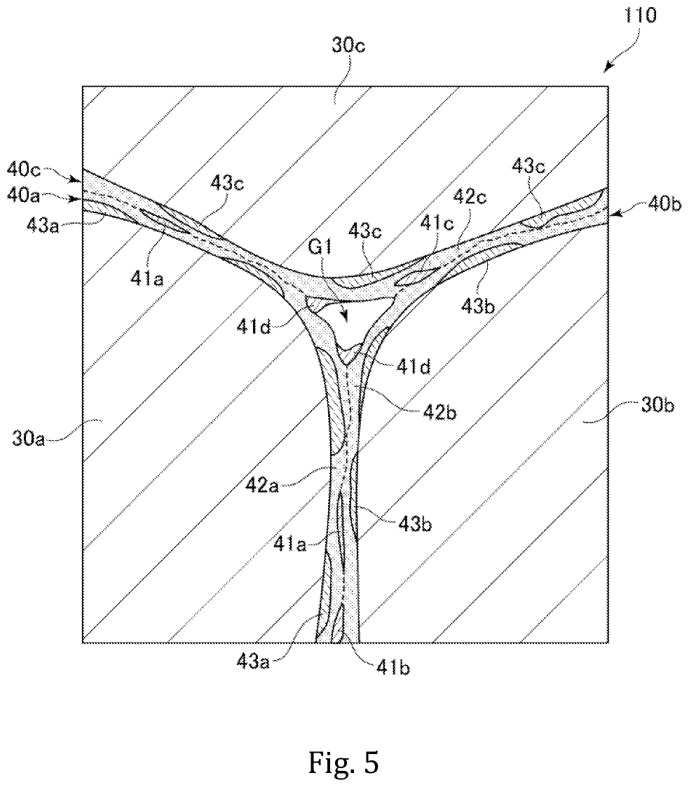

The following describes a base body 110 to which the present invention is applied, with reference to FIG. 5. FIG. 5 is an enlarged sectional view schematically showing a part of a cross section of the base body 110. The cross section of the base body 110 shown in FIG. 5 in an enlarged scale is positioned around the boundary of three soft magnetic metal particles. As shown, the base body 110 contains a first soft magnetic metal particle 30a, a second soft magnetic metal particle 30b, and a third soft magnetic metal particle 30c. The first soft magnetic metal particle 30a, the second soft magnetic metal particle 30b, and the third soft magnetic metal particle 30c are positioned adjacent to each other. As mentioned above, the first soft magnetic metal particle 30a is covered by the first insulating film 40a, and the second soft magnetic metal particle 30b is covered by the second insulating film 40b. Likewise, the third soft magnetic metal particle 30c is covered by the third insulating film 40c. The third insulating film 40c is configured in the same manner as the first insulating film 40a and the second insulating film 40b. Specifically, the third insulating film 40c contains a first oxide region 41c, a second oxide region 42c, and a third oxide region 43c. The second oxide region 42c covers a first surface region 31c, which is a part of the surface of the third soft magnetic metal particle 30c, and the second oxide region 42c contains the oxide of the element A as the main component. The third oxide region 43c covers a second surface region 32c, which is a part of the surface of the third soft magnetic metal particle 30c, and the third oxide region 43c contains the oxide of the element B as the main component. The first oxide region 41c is spaced apart from the surface of the third soft magnetic metal particle 30c, and the first oxide region 41c contains oxides of Fe and Cr. As with the first oxide regions 41a and 41b, the first oxide region 41c contains chromite (FeCr₂O₄). The first oxide region 41c may contain hematite (Fe₂O₃) and magnetite (Fe₃O₄) in addition to chromite (FeCr₂O₄). When the first oxide region 41c contains chromite, hematite, and magnetite, the content percentage of chromite is the highest, and the content percentage of magnetite is the lowest.

In the base body 110, there is a gap between the soft magnetic metal particles that is not filled with the insulating films. For example, as shown in FIG. 5, a gap G1 is present among the first soft magnetic metal particle 30a, the second soft magnetic metal particle 30b, and the third soft magnetic metal particle 30c in the base body 110. At least a part of the gap G1 is defined by a first oxide region 41d, which contains oxides of Fe and Cr. In other words, the first oxide region 41d is positioned to face the gap among the soft magnetic metal particles. As with the first oxide regions 41a to 41c, the first oxide region 41d may contain hematite (Fe₂O₃) and magnetite (Fe₃O₄) in addition to chromite (FeCr₂O₄). When the first oxide region 41d contains chromite, hematite, and magnetite, the content percentage of chromite is the highest, and the content percentage of magnetite is the lowest.

In the base body 110, a part of the gap between the soft magnetic metal particles is filled by the first oxide region 41d, and thus the mechanical strength of the base body 110 can be improved as compared to the case where the first oxide region 41d is not present. When the content percentage of chromite is the highest in the first oxide region 41d, the mechanical strength of the base body 110 can be further improved, because the chromite has a high hardness.

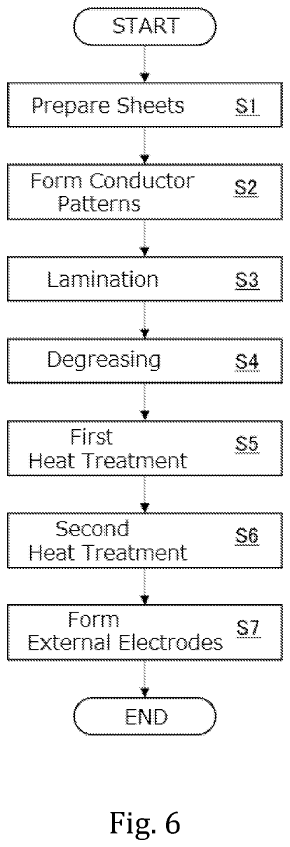

Next, one example of a manufacturing method of the coil component 1 will be described with reference to FIG. 6. Since the base body 10 is fabricated in the process of manufacturing the coil component 1, the manufacturing method of the base body 10 is also described with reference to FIG. 6. FIG. 6 is a flowchart showing a manufacturing method of the coil component 1 according to one embodiment of the present invention. In the following, it is assumed that the coil component 1 is manufactured by the sheet lamination method. The coil component 1 may also be manufactured by any known methods other than the sheet lamination method. For example, the coil component 1 may be manufactured by a lamination method such as a printing lamination method, a thin-film process method, or a slurry build method.

In the first step S1, magnetic sheets are fabricated. The magnetic sheets are produced from a magnetic material paste which is obtained by mixing and kneading soft magnetic metal powder (raw powder), which is the raw material of the soft magnetic metal particles, with a binder resin and a solvent. The raw powder is formed of a soft magnetic metal material. The raw powder contains Fe, Cr, the element A, and the element B. In the following description of the manufacturing method, for clarity of description, it is assumed that the raw powder contains Al as the element A and Si as the element B. The raw powder contains 95 wt % or more Fe. The total of the content percentages of additive elements other than Cr, the element A, and the element B is 5 wt % or less. The raw powder may contain 0.5 to 1.5 wt % Cr. The raw powder may contain 1 to 3 wt % Al. The raw powder may contain 0.5 to 3 wt % Si. The content percentage of Al in the raw powder may be higher than that of Si.

The binder resin for the magnetic material paste is, for example, an acrylic resin. The binder resin for the magnetic material paste may be epoxy resins, polyimide resins, resins known as binder resins other than those mentioned above, or mixtures thereof. One example of the solvent is toluene. The magnetic material paste is applied to the surface of a plastic base film by the doctor blade method or other common methods. The magnetic material paste applied to the surface of the base film is dried to obtain sheet-shaped molded bodies. A molding pressure of approximately 10 MPa to 100 MPa is applied for molding to the sheet-shaped molded bodies in the mold, so that a plurality of magnetic sheets are obtained.

Next, in step S2, a conductive paste is applied to some of the plurality of magnetic sheets prepared in step S1. The conductive paste is produced by mixing and kneading conductive powder made of conductive materials having excellent conductivity, such as Ag Pd, Cu, Al or alloys of these, with a binder resin and a solvent. The binder resin for the conductive paste may be the same as the binder resin for the magnetic material paste. Both the binder resins for the conductive paste and the magnetic material paste may be acrylic resins.

By applying the conductive paste to the magnetic sheets, unfired conductor patterns to be the conductor patterns C11 to C17 after firing are formed on the associated magnetic sheets. A through hole is formed in some of the magnetic sheets to penetrate the magnetic sheets in the stacking direction. When the conductive paste is applied to a magnetic sheet with a through hole, the conductive paste is also filled into the through hole. In this way, unfired via conductors are formed in the through-holes of the magnetic sheets, and these unfired via conductors will be via conductors V1 to V6 after firing. The conductive paste is applied to the magnetic sheets by, for example, screen printing.

Next, in step S3, the magnetic sheets prepared in step S1 are stacked together to form a top laminate to be the top cover layer 18, an intermediate laminate to be the body layer 20, and a bottom laminate to be the bottom cover layer 19. The top laminate and the bottom laminate are each formed by stacking four magnetic sheets prepared in step S1 and having no unfired conductor pattern formed thereon. The four magnetic sheets of the top laminate will be the magnetic films 18a to 18d respectively in the finished coil component 1, and the four magnetic sheets of the bottom laminate will be the magnetic films 19a to 19d respectively in the finished coil component 1. The intermediate laminate is formed by stacking in a predetermined order seven magnetic sheets each having an unfired conductor pattern formed thereon. The seven magnetic sheets of the intermediate laminate will be the magnetic films 11 to 17 respectively in the finished coil component 1. The intermediate laminate formed in the above-described manner is sandwiched between the top laminate on the top side and the bottom laminate on the bottom side, and the top laminate and the bottom laminate are bonded to the intermediate laminate by thermal compression to obtain a body laminate. Next, the body laminate is diced to a desired size by using a cutter such as a dicing machine or a laser processing machine to obtain a chip laminate. The chip laminate is an example of a molded body that includes a substrate body to be the base body 10 after the heat treatment and unfired conductor patterns to be the coil conductor 25 after the heat treatment. The molded body that includes the substrate body to be the base body 10 after the heat treatment and the unfired conductor patterns to be the coil conductor 25 after the heat treatment may be fabricated by a method other than the sheet lamination method.

In the molded body fabricated in step S3, the filling factor of the raw powder is 85% or higher. The filling factor of the raw powder in the molded body is achieved by adjusting the molding pressure for molding the magnetic sheets in accordance with the type of binder resin, the particle size of the raw powder, and other parameters. Therefore, in step S3, the magnetic sheets are molded at a molding pressure at which the filling factor of the raw powder in the molded body is 85% or higher. The filling factor of the raw powder in the molded body can be the proportion of the area occupied by the raw powder to the entire area of the observed field of view in a SEM image of a cross section of the molded body, expressed in percentage.

Next, in step S4, the molded body fabricated in step S3 is degreased. In the case where a thermally decomposable resin is used as the binder resin for the magnetic material paste and the conductive paste, the degreasing process for the molded body may be performed in a non-oxygen atmosphere such as a nitrogen atmosphere. By performing the degreasing process in a non-oxygen atmosphere, the oxidation of Fe contained in the raw powder can be prevented during the degreasing process. The degreasing process is performed at a temperature higher than the thermal decomposition starting temperature of the binder resin for the magnetic material paste. In the case where an acrylic resin is used as the binder resin for the magnetic material paste, the degreasing process is performed at a temperature higher than the thermal decomposition starting temperature of the acrylic resin, e.g., 300° C. to 500° C. Since the degreasing process decomposes the thermally decomposable resin contained in the molded body, no thermally decomposable resin remains in the molded body after the degreasing process is completed. When the binder resin for the conductive paste is the same thermally decomposable resin as the binder resin for the magnetic material paste, the thermally decomposable resin contained in the unfired conductor patterns is also thermally decomposed during the degreasing process in step S4. Thus, in step S4, both the magnetic sheets and the unfired conductor patters constituting the molded body are degreased.

Next, in step S5, the degreased molded body is subjected to first heat treatment. The first heat treatment is performed in a low oxygen concentration atmosphere containing oxygen in a range of 5 to 1000 ppm at a first heating temperature of 750° C. to 900° C. The first heat treatment may be performed in a low oxygen concentration atmosphere of 5 to 10 ppm. Since the raw powder is heated at 750° C. to 900° C., Cr, Al, and Si in each raw powder diffuse to the vicinity of the surface by thermal diffusion and combine with oxygen in the atmosphere. In the first heat treatment, oxides of Al and Si, which are easily oxidized, are produced among the additive elements transferred to the surface of the raw powder. As shown in FIGS. 4 and 5, the first heat treatment forms an oxide region composed mainly of the oxide of Al (e.g., the second oxide region 42a) and an oxide region composed mainly of the oxide of Si (e.g., the third oxide region 43a) on the surface of the heated raw powder. The first heating time during which the first heat treatment is performed can be between 1 and 6 hours. The first heating time may be, for example, one hour. In the first heat treatment, Fe, which is less oxidizable than Al and Si, may be slightly oxidized. Since the first heat treatment is performed in a low oxygen concentration atmosphere, oxidation of Fe produces more magnetite (Fe₃O₄) than hematite (Fe₂O₃) as oxides of Fe. In the first heat treatment, the oxides of Fe are produced on the radially outer side of the second oxide region 42a and the third oxide region 43a.

Next, in step S6, the molded body having been heated in the first heat treatment is subjected to second heat treatment at a higher oxygen concentration than in the first heat treatment. The second heat treatment may be performed in a low oxygen atmosphere of higher than 1000 ppm and equal to or lower than 10000 ppm. Since the second heat treatment is performed at a higher oxygen concentration than the first heat treatment, the oxidation of Si and Al is further progressed in the second heat treatment. In the second heat treatment, magnetite produced in the first heat treatment combines with Cr to form chromite (FeCr₂O₄). As mentioned above, the filling factor of the raw powder in the molded body is as high as 85% or higher, and thus the excessive supply of oxygen to the surface of the raw powder can be inhibited. Therefore, in the second heat treatment, chromite (FeCr₂O₄) is more likely to be formed than hematite (Fe₂O₃) or chromium oxide (III) in the region where magnetite and Cr element are present near the surface of the raw powder. Thus, the second heat treatment produces an oxide region (e.g., the first oxide region 41a) containing chromite at a high content percentage on the radially outer side of the second oxide region 42a or the third oxide region 43a.

Previously, the usefulness of chromite contained in magnetic base body was not recognized. Therefore, although raw powder containing Fe and Cr was used in the conventional methods of producing a magnetic base body, there was no known method of producing chromite from this raw powder. In the present application, the molded body with a filling factor of the raw powder of 85% or higher is first subjected to heat treatment at a low oxygen concentration (the first heat treatment in step S5), and the molded body having been subjected to the first heat treatment is subsequently subjected to heat treatment at a higher oxygen concentration than in the first heat treatment (the second heat treatment in step S6), such that the magnetite produced in the first heat treatment is combined with Cr to produce chromite. As a result, the content percentage of the chromite is the highest among those of chromite, hematite, and magnetite in the oxide regions containing Fe and Cr. Since magnetite is consumed to produce chromite, the content percentage of magnetite can be the lowest among those of chromite, hematite, and magnetite in the oxide regions containing Fe and Cr.

According to the manufacturing method shown in FIG. 6, the filling factor of the raw powder in the molded body is 85% or higher, and both the first heat treatment and the second heat treatment are performed in a low oxygen concentration atmosphere. Thus, the amount of oxygen supplied to the surface of the raw powder is limited. If excess oxygen is present around the raw powder in the second heat treatment, chromite contacts with oxygen under a high temperature and thus is likely to change into Fe₂O and Cr₂O₃. However, since the filling factor of the raw powder is 85% or higher and the second heat treatment is performed in a low oxygen atmosphere, the generated chromite can be inhibited from changing into other oxides. Also, since the filling factor of the raw powder in the molded body is high (e.g., 85% or higher), the range of oxygen concentration in the atmosphere in which the second heat treatment is performed can be expanded (i.e., the upper limit can be raised).

Since the filling factor of the raw powder in the molded body is 85% or higher, and the first heat treatment and the second heat treatment are performed in a low oxygen concentration atmosphere, the insulating films can be inhibited from growing excessively due to a large supply of oxygen to the raw powder. The manufacturing method of the present invention can control the thickness of the insulating films to 20 nm or less. This ensures excellent voltage resistance in the finished base body 10 without reducing the filling factor of the soft magnetic metal particles. Since the filling factor of the raw powder in the molded body before heating is 85% or higher, and the thickness of the insulating films generated by heating the molded body is controlled, the filling factor of the soft magnetic metal particles in the base body 10 can also be maintained at about 85%.

During the second heat treatment, in addition to oxidation of the raw powder, sintering of the conductive powder in the unsintered conductor patterns also occurs. The coil conductor 25 is obtained by sintering the conductive powder in the unsintered conductor patterns. When copper powder is used as the conductive powder, the copper crystals sinter densely to form the coil conductor 25.

The second heat treatment is performed at a second heating temperature and for a second heating time. The second heating temperature and the second heating time are determined such that insulating films with a sufficient thickness enough to ensure insulation are formed on the surface of the raw powder. The second heating temperature may be, for example, between 500° C. and 700° C. The higher the second heating temperature, the faster the oxidation progresses, so the second heating time depends on the second heating temperature. When the second heating temperature is 500° C., the second heating time may be from one to six hours. When the second heating temperature is 700° C., the second heating time may be from 30 minutes to one hour.

Thus, the raw powder contained in the molded body is oxidized through the first heat treatment and the second heat treatment to produce, from the raw powder, soft magnetic metal particles with a surface covered by an insulating film. Specifically, as shown in FIG. 4 or 5, the first insulating film 40a is generated so as to include the oxide region 41a containing chromite, and the second insulating film 40b is generated so as to include the oxide region 41b containing chromite. The second heat treatment causes adjacent ones of the soft magnetic metal particles to bond with each other via insulating films formed on their surfaces. In this way, the base body 10 containing soft magnetic metal particles bonded to each other is obtained.

Next, in step S7, the external electrode 21 and the external electrode 22 are formed on the surface of the base body 10 obtained in step S6. The external electrode 21 is connected to one end of the coil conductor 25, and the external electrode 22 is connected to the other end of the coil conductor 25. The molded body having gone through the second heat treatment may be impregnated with a resin before the external electrodes 21 and 22 are formed. The molded body is impregnated with, for example, a thermosetting resin such as an epoxy resin. This allows the resin to penetrate the gaps between the soft magnetic metal particles in the base body 10. The resin that has penetrated into the base body 10 may be set to increase the mechanical strength of the base body 10.

The coil component 1 is fabricated through the steps described above.

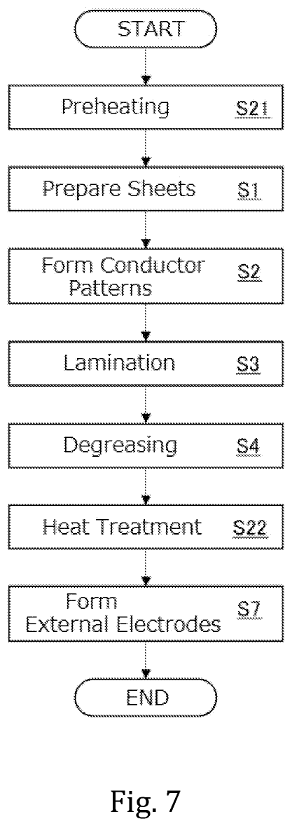

Next, another aspect of the manufacturing method of the coil component 1 will be described with reference to FIG. 7. The manufacturing method shown in FIG. 7 differs from that shown in FIG. 6 in that before the magnetic sheets are fabricated, the raw powder is preheated to produce oxides of the element B on the surface of the raw powder.

As shown in FIG. 7, in the first step S21, the raw powder, which is the raw material for the soft magnetic metal particles, is prepared and then preheated. The preheating is performed at a temperature lower than 500° C. for one hour. The preheating discretely produces oxides of the element B (Si or Ti) on the surface of the raw powder. Using this raw powder having the oxides of the element B discretely formed on the surface thereof, steps S1 to S3 are performed as in FIG. 6 to produce a molded body including the magnetic sheets stacked together. In step S4, the molded body is degreased.

Next, in step S22, the degreased molded body is subjected to heat treatment. The heat treatment in step S22 can be performed under the same conditions as the second heat treatment performed in step S6 of FIG. 6. Thus, the element A in the raw powder contained in the molded body is oxidized through the second heat treatment to produce oxides of the element A, thereby producing, from the raw powder, soft magnetic metal particles with a surface covered by an insulating film. The heat treatment in step S22 causes adjacent ones of the soft magnetic metal particles to bond with each other via insulating films formed on their surfaces. In this way, the base body 10 containing soft magnetic metal particles bonded to each other is obtained.

Next, in step S7, the external electrode 21 and the external electrode 22 are formed on the surface of the base body 10 obtained in step S22. The coil component 1 is fabricated through the steps described above.

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

This specification also discloses the following embodiments.

### Additional Embodiment 1

A magnetic base body comprising:

a plurality of soft magnetic metal particles; and

a plurality of insulating films covering surfaces of the plurality of soft magnetic metal particles,

wherein the plurality of soft magnetic metal particles include a first soft magnetic metal particle,

wherein the plurality of insulating films include a first insulating film covering a surface of the first soft magnetic metal particle, and

wherein the first insulating film includes one or more first oxide regions, the one or more first oxide regions containing Fe and Cr and having a peak intensity at 730 cm⁻¹ in a Raman spectrum obtained by Raman spectrometry.

### Additional Embodiment 2

The magnetic base body of Additional Embodiment 1, wherein the peak intensity at 730 cm⁻¹ in the Raman spectrum obtained by Raman spectrometry in the one or more first oxide regions is higher than a peak intensity at 680 cm⁻¹ in the Raman spectrum obtained by Raman spectrometry in the one or more first oxide regions.

### Additional Embodiment 3

The magnetic base body of Additional Embodiment 1 or 2,

wherein the peak intensity at 730 cm⁻¹ in the Raman spectrum obtained by Raman spectrometry in the one or more first oxide regions is higher than a peak intensity at 300 cm⁻¹ in the Raman spectrum obtained by Raman spectrometry in the one or more first oxide regions.

### Additional Embodiment 4

The magnetic base body of any one of Additional Embodiments 1 to 3, wherein the one or more first oxide regions are spaced apart from the surface of the first soft magnetic metal particle.

### Additional Embodiment 5

The magnetic base body of any one of Additional Embodiments 1 to 4, wherein the first insulating film includes a plurality of first oxide regions, the plurality of first oxide regions containing Fe and Cr and having a peak intensity at 730 cm⁻¹ in a Raman spectrum obtained by Raman spectrometry, and wherein the plurality of first oxide regions are spaced apart from each other.

### Additional Embodiment 6

The magnetic base body of Additional Embodiment 5, wherein the plurality of first oxide regions are spaced apart from each other in a circumferential direction around a geometric center of the first soft magnetic metal particle.

### Additional Embodiment 7

The magnetic base body of any one of Additional Embodiments 1 to 6,

wherein the plurality of soft magnetic metal particles include a second soft magnetic metal particle and a third soft magnetic metal particle, the second soft magnetic metal particle being adjacent to the first soft magnetic metal particle, the third soft magnetic metal particle being adjacent to the first and second soft magnetic metal particles, and

wherein at least a part of a gap present among the first soft magnetic metal particle, the second soft magnetic metal particle, and the third soft magnetic metal particle is defined by the one or more first oxide regions.

### Additional Embodiment 8

The magnetic base body of any one of Additional Embodiments 1 to 7,

wherein the first insulating film further includes one or more second oxide regions and one or more third oxide regions, the one or more second oxide regions containing an oxide of an element A as a main component and covering a first surface region constituting a part of the surface of the first soft magnetic metal particle, the one or more third oxide regions containing an oxide of an element B as a main component and covering a second surface region of the first soft magnetic metal particle different from the first surface region.

### Additional Embodiment 9

The magnetic base body of Additional Embodiment 8, wherein the one or more first oxide regions are located on a radially outer side of the one or more second oxide regions.

### Additional Embodiment 10

The magnetic base body of any one of Additional Embodiments 1 to 9, wherein each of the plurality of soft magnetic metal particles contains Fe and Si.

### Additional Embodiment 11

The magnetic base body of Additional Embodiment 10, wherein a content percentage of Fe in each of the plurality of soft magnetic metal particles is 95 wt % or more.

### Additional Embodiment 12

The magnetic base body of Additional Embodiment 8,

wherein the element B is more apt to oxidation than Fe, and

wherein the element A is more apt to oxidation than the element B.

### Additional Embodiment 13

The magnetic base body of Additional Embodiment 12,

wherein the element A is Al, and

wherein the element B is Si.

### Additional Embodiment 14

A coil component comprising:

the magnetic base body of any one of Additional Embodiments 1 to 13, and

a coil conductor provided in the magnetic base body.

### Additional Embodiment 15

A circuit board comprising the coil component of Additional Embodiment 14.

### Additional Embodiment 16

An electronic device comprising the circuit board of Additional Embodiment 15.

### Additional Embodiment 17

A magnetic base body comprising:

a plurality of soft magnetic metal particles; and

a plurality of insulating films covering surfaces of the plurality of soft magnetic metal particles,

wherein the plurality of soft magnetic metal particles include a first soft magnetic metal particle,

wherein the plurality of insulating films include a first insulating film covering a surface of the first soft magnetic metal particle, and

wherein the first insulating film contains Fe and Cr.

What is claimed is:

1. A magnetic base body comprising:
a plurality of soft magnetic metal particles; and
a plurality of insulating films covering surfaces of the plurality of soft magnetic metal particles,
wherein the plurality of soft magnetic metal particles include a first soft magnetic metal particle,
wherein the plurality of insulating films include a first insulating film covering a surface of the first soft magnetic metal particle, and
wherein the first insulating film includes one or more first oxide regions, the one or more first oxide regions containing Fe and Cr and having a peak intensity at 730 cm⁻¹ in a Raman spectrum obtained by Raman spectrometry.

2. The magnetic base body of claim 1, wherein the peak intensity at 730 cm⁻¹ in the Raman spectrum obtained by Raman spectrometry in the one or more first oxide regions is higher than a peak intensity at 680 cm⁻¹ in the Raman spectrum obtained by Raman spectrometry in the one or more first oxide regions.

3. The magnetic base body of claim 1, wherein the peak intensity at 730 cm⁻¹ in the Raman spectrum obtained by Raman spectrometry in the one or more first oxide regions is higher than a peak intensity at 300 cm⁻¹ in the Raman spectrum obtained by Raman spectrometry in the one or more first oxide regions.

4. The magnetic base body of claim 1, wherein the one or more first oxide regions are spaced apart from the surface of the first soft magnetic metal particle.

5. The magnetic base body of claim 1,
wherein the first insulating film includes a plurality of first oxide regions, the plurality of first oxide regions containing Fe and Cr and having a peak intensity at 730 cm⁻¹ in a Raman spectrum obtained by Raman spectrometry, and
wherein the plurality of first oxide regions are spaced apart from each other.

6. The magnetic base body of claim 4, wherein the plurality of first oxide regions are spaced apart from each other in a circumferential direction around a geometric center of the first soft magnetic metal particle.

7. The magnetic base body of claim 1,
wherein the plurality of soft magnetic metal particles include a second soft magnetic metal particle and a third soft magnetic metal particle, the second soft magnetic metal particle being adjacent to the first soft magnetic metal particle, the third soft magnetic metal particle being adjacent to the first and second soft magnetic metal particles, and
wherein at least a part of a gap present among the first soft magnetic metal particle, the second soft magnetic metal particle, and the third soft magnetic metal particle is defined by the one or more first oxide regions.

8. The magnetic base body of claim 1, wherein the first insulating film further includes one or more second oxide regions and one or more third oxide regions, the one or more second oxide regions containing an oxide of an element A as a main component and covering a first surface region constituting a part of the surface of the first soft magnetic metal particle, the one or more third oxide regions containing an oxide of an element B as a main component and covering a second surface region of the first soft magnetic metal particle different from the first surface region.

9. The magnetic base body of claim 8, wherein the one or more first oxide regions are located on a radially outer side of the one or more second oxide regions.

10. The magnetic base body of claim 1, wherein each of the plurality of soft magnetic metal particles contains Fe and Si.

11. The magnetic base body of claim 10, wherein a content percentage of Fe in each of the plurality of soft magnetic metal particles is 95 wt % or more.

12. The magnetic base body of claim 8,
wherein the element B is more apt to oxidation than Fe, and
wherein the element A is more apt to oxidation than the element B.

13. The magnetic base body of claim 12,
wherein the element A is Al, and
wherein the element B is Si.

14. A coil component comprising:
the magnetic base body of claim 1, and
a coil conductor provided in the magnetic base body.
